(19) United States
(12) Patent Application Publication
(10) Pub. No.: US 2008/0088217 A1
(43) Pub. Date: Apr. 17, 2008

(54) PLASMA GENERATING DEVICE, METHOD OF CLEANING DISPLAY PANEL, AND METHOD OF MANUFACTURING DISPLAY PANEL USING THE SAME

(75) Inventors: Tae-Wan KIM, Seoul City (KR); Chang Heon YI, Seoul City (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/867,059

(22) Filed: Oct. 4, 2007

(30) Foreign Application Priority Data
Oct. 17, 2006 (KR) 10-2006-0100859

(51) Int. Cl. H05H 1/00; H01J 9/02

(52) U.S. Cl. 313/231.31; 445/24

(57) ABSTRACT

The present invention relates to a plasma generating device, a method of cleaning a panel, and a method of manufacturing a display panel using the same. In the present invention, a pair of dielectric plates 52 and 52′ are detachably installed to a nozzle head 50. To this end, an upper end of the dielectric plate 52 or 52′ is inserted into a seating slit 49 formed in a lower portion of a chamber housing 46, and a lower end of the dielectric plate 52 or 52′ is securely placed on and fixed to a stepped portion 59 formed in a lower end of an electrode cover 58. Further, in order to maintain a gap 53h between the dielectric plates 52 and 52′, spacers 64 are inserted in both ends of the gap 53h. According to the present invention so configured, uniform plasma can be generated since the gap between the dielectric plates can be kept constant. Further, the dielectric plates can be easily exchanged and maintained.

### BACKGROUND OF THE INVENTION

1. Field of the Invention

The present invention relates to a plasma generating device, and more particularly, to a device for performing surface treatment such as deposition, cleaning, ashing and etching on a display panel by applying a radio frequency (REF) power between dielectrics to convert gas flowing between the dielectrics into a plasma state.

2. Description of the Related Art

Herein, a system for generating plasma under an atmospheric pressure, i.e. a system for generating atmospheric pressure plasma will be mainly explained.

FIG. 1 is schematic view of a conventional atmospheric pressure plasma generating device. As shown in FIG. 1, the plasma generating device includes a gas chamber 10 in which gases are introduced and mixed. A reinforcing cover 12 is installed below the gas chamber 10 to support and protect electrodes 14 and 14′. The electrodes 14 and 14′ include a first electrode 14 and a second electrode 14′ which face each other, and dielectric layers 15 are coated on external surfaces of the electrodes 14 and 14′. Furthermore, the first electrode 14 is connected to a RF power supply 18 for applying RF, and the second electrode 14′ is grounded.

In the conventional device so configured, if a reaction gas generated in the gas chamber 10 is caused to flow between the dielectric layers 15 in a state where RF is applied between the first and second electrodes 14 and 14′, the gas becomes into a plasma state. At this time, the plasma is injected onto a panel 19 positioned below the reinforcing cover 12, so that an upper surface of the panel 19 can be surface treated by the plasma.

However, the above conventional device has the following problems. The conventional atmospheric pressure plasma generating device is manufactured by coating the dielectric layers 15 on the outer surfaces of the electrodes 14 and 14′. This coating process includes a thermal spraying process. More specifically, a material which will be formed into the dielectric layer 15 is melted into a solution which in turn is blown by an air stream in a fog pattern to adhere to a surface of the electrode.

The dielectric formed in this way is porous, and thus, the coating is imperfect and its structure is not dense. As a result, the uniformity of plasma may be deteriorated.

Further, since the dielectric layer 15 is kept at a high temperature solution state, the electrodes 14 and 14′ may be thermally deformed in the process of coating the electrodes 14 and 14′ with the plasma through a thermal spraying process. If the electrodes 14 and 14′ are deformed, a gap between the electrodes 14 and 14′ cannot be kept constant, and a flow rate of reaction gas is thus changed. If the flow rate of reaction gas is changed, the uniformity of plasma is also deteriorated. Particularly, in a case where the thermal spraying process is employed, it is difficult to manufacture electrode and dielectric applicable to a large area panel.

Furthermore, the conventional device is expensive to manufacture, since the dielectric layer 15 is thermally sprayed on the electrodes 14 and 14′. Moreover, since the electrodes 14 and 14′ are integrally formed with the dielectric layers 15, the whole electrodes 14 and 14′ should be exchanged even though only the dielectric layer 15 is damaged. Therefore, large exchange costs are necessary and the maintenance is also difficult.

### SUMMARY OF THE INVENTION

The present invention is conceived to solve the aforementioned problems in the prior art. Accordingly, it is an object of the present invention to provide a plasma generating device wherein deformation of electrodes is minimized and a gap between dielectrics is kept constant.

It is another object of the present invention to provide a plasma generating device applicable to a large area panel and easy to maintain.

According to an aspect of the present invention for achieving the above objects, there is provided a plasma generating device, which comprises a chamber housing extending in a longitudinal direction and including a gas chamber in which reaction gas is mixed, a pair of dielectric plates installed below the chamber housing to face each other such that the reaction gas is converted into plasma in a gap between the dielectric plates, a pair of electrodes provided in parallel to outward surfaces of the dielectric plates, and electrode covers for surrounding the electrodes.

The dielectric plates may be detachably installed.

Each of the dielectric plates may be coupled with the chamber housing in such a manner that an upper end of the dielectric plate is fitted into a seating slit recessed to a depth from a lower end of the chamber housing and formed into a shape corresponding to the upper end of the dielectric plate.

A stepped portion may be formed on a lower portion of the electrode cover such that a lower end of the dielectric plate is placed thereon.

Further, spacers for maintaining an interval between the dielectric plates may be inserted in the gap at both ends of the dielectric plates.

The spacer may be inserted and fixed into a seating groove formed in a vertical direction at the center of an end cover that is coupled to either end of the electrode cover.

A connection slit for connecting the gas chamber and the gap between the dielectric plates may be formed in a lower portion of the chamber housing to pass through the chamber housing in a longitudinal direction.

Furthermore, a cooling line through which fluid for cooling heat generated from the electrode passes may be installed to the electrode.

The electrode cover may be formed of an Ultem material.

A reinforcing plate may be installed to an outer surface of the electrode cover, and an adjusting bolt may be threaded through the reinforcing plate to allow a front end of the adjusting bolt to come into contact with the outer surface of the electrode cover.

The plasma generating device of the present invention may further comprise a main body formed on the chamber housing, wherein the main body is made of aluminum and includes a gas inlet for temporarily storing gas introduced from the outside and a connection passage for connecting the gas inlet and the gas chamber.

According to another aspect of the present invention, there is provided a method of cleaning a panel, which comprises a first process of injecting reaction gas into a gas inlet formed in a main body of a gas supply channel, a second process of introducing the gas filled in the gas inlet into a gas chamber, a third process of mixing the reaction gas with a carrier gas in the gas chamber, a fourth process of introducing the mixed gas into a gap between dielectric plates through a connection slit formed in a lower portion of the gas chamber to extend in a longitudinal direction, and a fifth process of cleaning the panel by causing radicals, which are generated while the mixed gas is converted into plasma within the gap between the dielectric plates, to be discharged onto an upper surface of the panel.

At this time, the panel may be positioned below the gap between the dielectric plates, and be then caused to relatively move with respect to the dielectric.

According to a further aspect of the present invention, there is provided a method of manufacturing a display panel, which comprises a process of depositing a pattern on a display panel, and the aforementioned the display panel cleaning process of removing impurities on the display panel.

According to the plasma generating device of the present invention, there is an advantage in that plasma can be uniformly generated since dielectric plates and electrodes are separately manufactured and assembled. Further, the plasma generating device of the present invention is easily applicable to a large area panel and allows for easy repair and maintenance.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a schematic view of a conventional atmospheric pressure plasma generating device;

FIG. 2 is a perspective view showing a plasma generating device according to a preferred embodiment of the present invention;

FIG. 3 is a sectional view of the plasma generating device according to the present invention, taken along line A-A′ of FIG. 2;

FIG. 4 is a longitudinal sectional view of the plasma generating device according to the present invention; and

FIG. 5 is a perspective view showing a state where a spacer and an end cover of the plasma generating device according to the present invention are coupled with each other.

### DESCRIPTION OF THE PREFERRED EMBODIMENT

Hereinafter, a plasma generating device according to a preferred embodiment of the present invention will be described in detail with reference to the accompanying drawings.

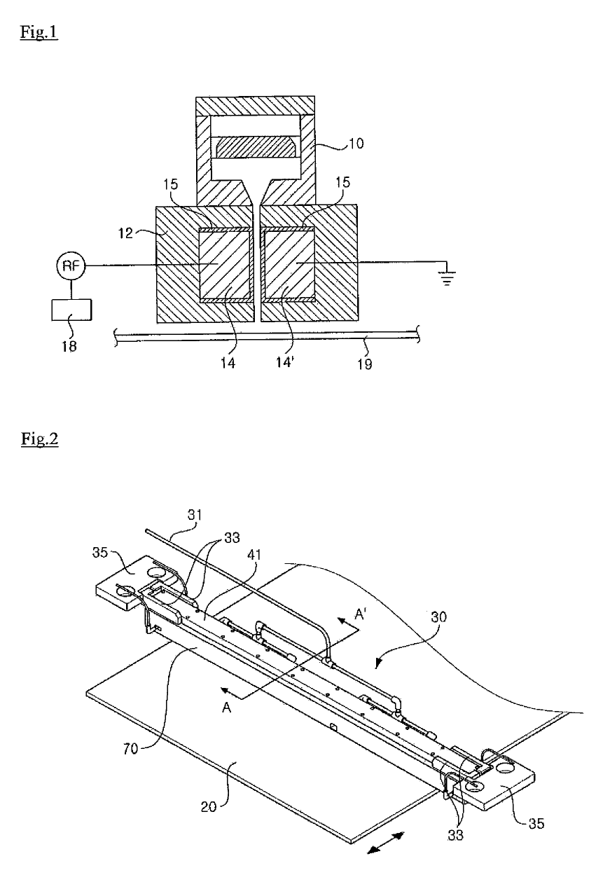

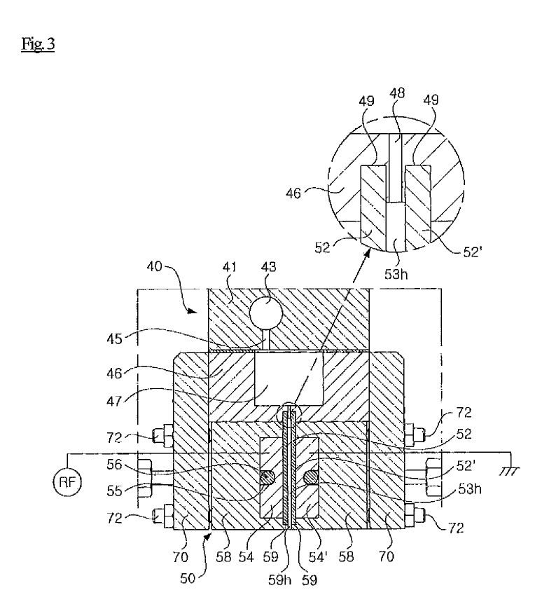

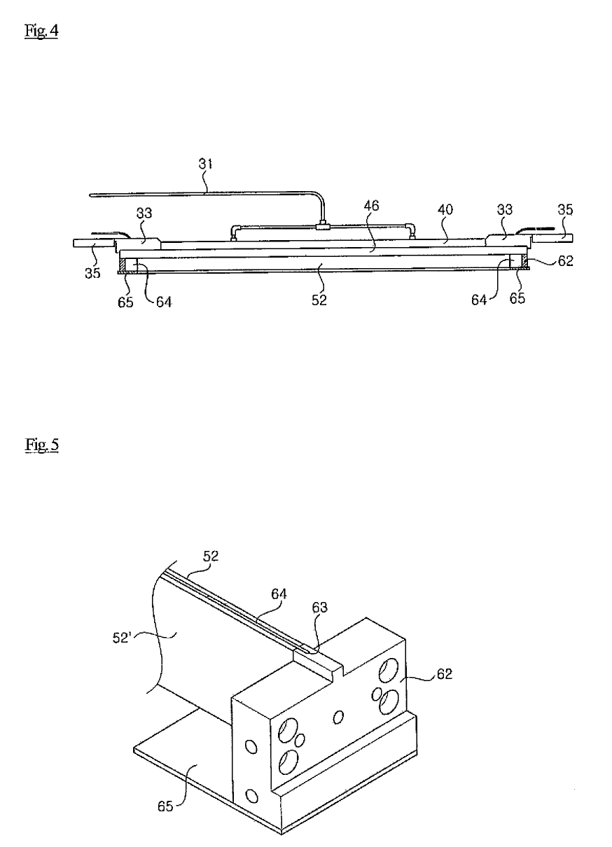

FIG. 2 is a perspective view of a plasma generating device according to a preferred embodiment of the present invention; FIG. 3 is a sectional view of the plasma generating device according to the present invention, taken along line A-A′ of FIG. 2; FIG. 4 is a longitudinal sectional view of the plasma generating device according to the present invention; and FIG. 5 is a perspective view showing a state where a spacer and an end cover of the plasma generating device according to the present invention are coupled with each other.

As shown in FIGS. 2 and 3, the plasma generating device of the present invention is provided above an object to be treated, i.e. a panel 20, which is securely placed on a stage (not shown). The plasma generating device includes a nozzle unit 30 formed in a length corresponding to a width of the panel 20, a power supply (not shown) for applying RF power to the nozzle unit 30, and a gas processing source (not shown) for supplying a reaction gas to the nozzle unit 30. In addition, the nozzle unit 30 and the gas processing source are connected through a gas supply line 31.

Both ends of the nozzle unit 30 are connected to support ends 35 by means of support brackets 33. Both ends of the nozzle unit 30 are fixed since the support ends 35 are supported by the support brackets 33. Meanwhile, the nozzle unit 30 and the panel 20 are moved relatively with respect to each other. For example, in this embodiment, the panel 20 is installed to move along a direction designated by an arrow of FIG. 2. However, the present invention is not limited thereto. That is, the nozzle unit 30 may also be installed to be movable with respect to the panel 20.

If power is applied to the nozzle unit 30, the reaction gas supplied from the gas processing source is activated into a plasma state to generate radicals, while passing through the interior of the nozzle unit 30 via the gas supply line 31. The generated radicals cause chemical reaction with a surface of the panel 20, so that they can be used for modifying, cleaning or etching the surface of the panel 20.

Above the nozzle unit 30 is provided a gas supply channel 40 for mixing gases introduced through the gas supply line 31 and transferring the mixed gas to a nozzle head 50. A main body 41 defines an upper appearance of the gas supply channel 40, and a gas inlet 43 is formed in the main body 41. The gas supply line 31 is connected to the gas inlet 43 through which gas can be introduced. In the main body 41 is also formed a connection passage 45 through which the gas inlet 43 can be connected to a gas chamber 47 to be explained later.

In the present invention, the main body 41 is formed of aluminum to facilitate maintaining strength of the main body 41 and also relatively reducing its weight. That is, since the weight of the body 41 installed above the nozzle unit 30 is decreased, it is possible to prevent the nozzle unit 30 from sagging even though the nozzle unit 30 is supported at only both ends thereof by means of the support ends 35.

Meanwhile, a chamber housing 46 is provided below the main body 41 and also defines a lower appearance of the gas supply channel 40. In the chamber housing 46 is also formed the gas chamber 47 which is connected to a lower end of the connection passage 45. Reaction gas used to generate plasma is mixed in the gas chamber 47.

A connection slit 48 for connecting a gap 53h between dielectric plates 52 and 52′, which will be explained later, with the gas chamber 47 is formed in a lower center of the chamber housing 46. That is, the connection slit 48 becomes a passage through which the reaction gas mixed in the gas chamber 47 is introduced into the gap 53h. In this embodiment, the connection slit 48 takes the shape of a slit passing through a central portion of the chamber housing 46 in a longitudinal direction and is formed to extend between both ends of the chamber housing 46.

Further, a structure for allowing the dielectric plates 52 and 52′ to be inserted therein is formed in a lower portion of the chamber housing 46. That is, seating slits 49 are formed at both sides of the connection slit 48, and the seating slits 49 are formed to extend between the opposite ends of the chamber housing 46 in a longitudinal direction. In addition, the seating slits 49 are recessed to a predetermined depth from the lower end of the chamber housing 46 and are shaped to correspond to upper ends of the dielectric plates 52 and 52′.

Furthermore, a pair of the dielectric plates 52 and 52′ are provided in the nozzle head 50 to face each other in parallel. Each of the dielectric plates 52 and 52′ takes the shape of a plate extending in a longitudinal direction and is provided perpendicularly to a top surface of the panel 20 at a predetermined interval. In addition, the upper ends of the dielectric plates 52 and 52′ are fitted into the seating slits 49 formed in the chamber housing 46. Since the dielectric plates 52 and 52′ are fitted respectively into the seating slits 49, the interval between the dielectric plates 52 and 52′ are kept constant at the upper ends of the dielectric plates 52 and 52′.

In this embodiment, the dielectric plates 52 and 52′ are beforehand formed of dielectric materials, separately from electrodes 54 and 54′ to be explained later. The dielectric plates 52 and 52′ are preferably made of Al₂O₃. Each of the dielectric plates 52 and 52′ preferably has a thickness of 1.5 mm to 3 mm.

In addition, between the dielectric plates 52 and 52′ is formed the predetermined gap 53h in which reaction gas is introduced through the connection slit 48 and is then activated into a plasma while passing through the gap 53h. The interval between the dielectric plates 52 and 52′, i.e. a width of the gap 53h between the dielectric plates 52 and 52′, is preferably 1.5 mm to 2.5 mm.

A pair of the electrodes 54 and 54′ are installed to come into surface contact with outward surfaces of the dielectric plates 52 and 52′. Each of the electrodes 54 and 54′ is shaped to correspond to the dielectric plate 52 or 52′, i.e. to extend in a longitudinal direction in parallel with each other. The first electrode 54 is connected to the power supply (not shown) to allow RF power to be applied thereto, and the second electrode 54′ is grounded.

A cooling line 56 is installed in a recessed portion 55 extending in a longitudinal direction on an outward surface of the electrode 54 or 54′ opposite to the surface which is brought into contact with the dielectric plate 52 or 52′. The cooling line 56 prevents the temperature of the electrode 54 or 54′ from being increased as the power is applied to the electrode 54 or 54′. That is, fluid flowing through the cooling line 56 is used to cause the electrodes 54 and 54′ to be cooled. This embodiment employs a water cooling process in such a manner that pure water free of ion components is supplied to the cooling lines 56.

Electrode covers 58 surrounding outer surfaces of the electrodes 54 and 54′ are provided outside of the electrodes 54 and 54′, respectively. That is, the electrodes 54 and 54′ are surrounded by the electrode covers 58, except their surfaces brought into contact with the dielectric plates 52 and 52′. Each of the electrode covers 58 is installed to be movable in a lateral direction with respect to the chamber housing 46.

Further, stepped portions 59 are formed in lower portions of the electrode covers 58, respectively, such that the lower ends of the dielectric plates 52 and 52′ can be securely placed thereon. That is, an upper surface of the stepped portion 59 supports the lower end of the dielectric plates 52 or 52′. The upper surface of the stepped portion 59 has a width corresponding to the width of the dielectric plate 52 or 52′, and thus, the gap 53h between the dielectric plates 52 and 52′ has the same width as a gap 59h between the stepped portions 59.

The electrode cover 58 is preferably made of an Ultem material, Ultem is a thermoplastic special plastic made through an extrusion molding process of a polyetherimide resin, which has good dielectric breakdown strength and low flammability. Therefore, the Ultem material is stable and exhibits high tensile strength even though continuous works are performed in heated water or steam. The Ultem material may be used for a medicine preparation apparatus due to good chemical resistance and good hygiene or otherwise as an RF insulator in electromagnetic communication equipment. In this embodiment, the electrode cover 58 is made of an Ultem material having a good insulating property to restrain arc discharge from the electrodes and also to avoid an electric shock accident when brought into contact with a human body.

Referring to FIGS. 4 and 5, end covers 62 are provided to both longitudinal ends of the electrode cover 58 to reinforce the longitudinal ends of the electrode cover 58. Each of the end covers 62 is coupled with the electrode cover 58 to support the ends of the dielectric plates 52 and 52′. In addition, a seating groove 63 is formed vertically along the center of the end cover 62, and a spacer 64 to be explained later is fitted into the seating groove 63. Further, a spacer support 65 for supporting a lower end of the spacer 64 is coupled to a lower portion of the end cover 62.

The spacers 64 are installed in the gap 53h between the dielectric plates 52 and 52′ at both longitudinal ends of the dielectric plate 52 and 52′. The spacer 64 is fixed such in a manner that one end thereof is fitted into the seating groove 63 formed in the end cover 62. Further, the lower end of the spacer 64 is supported by the spacer support 65. The spacer 64 is used for allowing the gap 53h between the dielectric plates 52 and 52′ to be kept constant. That is, the spacer 64 is formed into a plate shape and is fitted into the gap between the dielectric plates 52 and 52′ to thereby prevent the gap between the dielectric plates 52 and 52′ from being narrowed.

Furthermore, reinforcing plates 70 are provided at outer sides of the electrode covers 58, respectively. Each of the reinforcing plates 70 extends in a longitudinal direction at a height identical to the upper surface of the chamber housing 46. That is, the reinforcing plates 70 support both sides of the chamber housing 46 and both sides of the electrode covers 58. In addition, adjusting bolts 72 are threaded through the reinforcing plates 70 such that front ends of the adjusting bolts 72 come into contact with the outer sides of the electrode covers 58. If the adjusting bolts 72 are farther threaded and tightened at opposite sides in a direction in which they are closer to each other, the adjusting bolts 72 push the outer sides of the electrode covers 58 in the above direction to thereby narrow the interval between the electrode covers 58. This is to prevent the gap 53h between the dielectric plates 52 and 52′ from being widened while the dielectric plates 52 and 52′ are assembled.

Hereinafter, the operation of the plasma generating device according to the present invention so configured will be explained in detail.

Referring to FIGS. 2 to 5, a reaction gas is first introduced into the gas inlet 43 formed in the main body 41 of the gas supply channel 40 through the gas supply line 31. The gas filled in the gas inlet 43 flows into the gas chamber 47 through the connection passage 45 formed in a lower portion of the gas inlet. The reaction gas is mixed with a carrier gas within the gas chamber 47.

The reaction gas mixed in the gas chamber 47 is transferred to the gap between the dielectric plates 52 and 52′ through the connection slit 48. At this time, since the connection slit 48 is formed into a slit which passes through the lower center of the chamber housing 46 in a longitudinal direction according to the present invention, a flow rate of the reaction gas from the gas chamber 47 into the gap 53h between the dielectric plates 52 and 52′ is uniform throughout the entire length of the nozzle head 50.

In the meantime, if RF power is applied to a pair of the electrodes provided at the nozzle head 50, an electric field is formed in the gap 53h. Accordingly, a glow discharge occurs in the gap 53h, and thus, the reaction gas is converted into a plasma state. During this process, radicals are generated and are then discharged onto the top surface of the panel 20 provided below the nozzle head 50. Using the radicals generated in such a process, a cleaning process of removing impurities or a portion of pattern on the panel 20 is conducted. At this time, the cleaning process may be performed while the panel 20 and the nozzle head 50 are relatively moved with respect to each other.

The cleaning process may be employed in a method of manufacturing a liquid crystal display panel. For example, this cleaning process may be performed when depositing a pattern on a panel and then removing impurities from the panel in the process of manufacturing a liquid crystal display.

Meanwhile, in the present invention, dielectric materials are not thermally sprayed onto the electrodes 54 and 54′ but the separately prepared dielectric plates 52 and 52′ are inserted between the electrodes 54 and 54′. Therefore, it is possible to prevent the thermal deformation of the electrodes 54 and 54′. Since the electrodes 54 and 54′ are not deformed, a uniform electric field can be obtained.

Further, according to the present invention, the gap 53h between the dielectric plates 52 and 52′ can be kept uniformly and the dielectric plates 52 and 52′ can also be detachably coupled to the nozzle head 50. That is, the dielectric plates 52 and 52′ are installed to the nozzle head 50 in such a manner that the upper ends of the dielectric plates 52 and 52′ are fitted into the seating slits 49 formed in the lower end of the chamber housing 46 and the lower ends of the dielectric plates 52 and 52′ are also supported by the stepped portions 59 formed in the lower ends of the electrode covers 58 surrounding the electrodes 54 and 54′. In addition, the spacers are installed in the gap 53h at both ends of the dielectric plates 52 and 52′ in a longitudinal direction to maintain an interval between the dielectric plates 52 and 52′. Accordingly, since the width of the gap 53h between the dielectric plates 52 and 52′ is uniform throughout the entire length of the nozzle head 50, the flow of plasma injected from the gap 53h can be uniformly maintained. Therefore, uniform surface treatment can also be conducted on the top surface of a large area panel 20.

Meanwhile, in the present invention, the dielectric plates 52 and 52′ and the electrodes 54 and 54′ are separately prepared and then assembled with each other. Therefore, when the dielectric plates 52 and 52′ are merely damaged, only the dielectric plates 52 and 52′ can be exchanged.

The following effects can be expected from the plasma generating device according to the present invention as specifically described above.

First, since the deformation of electrodes is minimized in the present invention, a uniform electric field can be formed to generate uniform plasma. Further, since an interval between the dielectric plates is kept constant, plasma can be uniformly injected onto a large area panel. Therefore, uniform surface treatment can be conducted on the large area panel throughout the entire large area of the panel in an effective way.

Furthermore, according to the present invention, the dielectric plates and the electrodes are separately prepared and then assembled with each other. Therefore, since only the dielectric plates can be exchanged when the dielectric plates are merely damaged, exchange costs can be reduced. Moreover, reliability of the plasma generating device can also be enhanced due to easy maintenance.

While the present invention has been illustrated and described in connection with the accompanying drawings and the preferred embodiment, the present invention is not limited thereto and is defined by the appended claims. Therefore, it will be understood by those skilled in the art that various modifications and changes can be made thereto without departing from the spirit and scope of the invention defined by the appended claims.

1. A plasma generating device, comprising:
a chamber housing extending in a longitudinal direction and including a gas chamber in which reaction gas is mixed;
a pair of dielectric plates installed below the chamber housing to face each other such that the reaction gas is converted into plasma in a gap between the dielectric plates;
a pair of electrodes provided in parallel to outward surfaces of the dielectric plates; and
electrode covers for surrounding the electrodes.

2. The plasma generating device as claimed in claim 1, wherein the dielectric plates are detachably installed.

3. The plasma generating device as claimed in claim 2, wherein each of the dielectric plates is coupled with the chamber housing in such a manner that an upper end of the dielectric plate is fitted into a seating slit recessed to a depth from a lower end of the chamber housing and formed into a shape corresponding to the upper end of the dielectric plate.

4. The plasma generating device as claimed in claim 3, wherein a stepped portion is formed on a lower portion of the electrode cover such that a lower end of the dielectric plate is placed thereon.

5. The plasma generating device as claimed in claim 4, wherein spacers for maintaining an interval between the dielectric plates is inserted in the gap at both ends of the dielectric plates.

6. The plasma generating device as claimed in claim 5, wherein the spacer is inserted and fixed into a seating groove formed in a vertical direction at the center of an end cover that is coupled to either end of the electrode cover.

7. The plasma generating device as claimed in claim 1, wherein a connection slit for connecting the gas chamber and the gap between the dielectric plates is formed in a lower portion of the chamber housing to pass through the chamber housing in a longitudinal direction.

8. The plasma generating device as claimed in claim 7, wherein a cooling line through which fluid for cooling heat generated from the electrode passes is installed to the electrode.

9. The plasma generating device as claimed in claim 8, wherein the electrode cover is formed of an Ultem material.

10. The plasma generating device as claimed in claim 9, wherein a reinforcing plate is installed to an outer surface of the electrode cover, and an adjusting bolt is threaded through the reinforcing plate to allow a front end of the adjusting bolt to come into contact with the outer surface of the electrode cover.

11. The plasma generating device as claimed in claim 10, further comprising:
a main body formed on the chamber housing, wherein the main body is made of aluminum and includes a gas inlet for temporarily storing gas introduced from the outside and a connection passage for connecting the gas inlet and the gas chamber.

12. A method of cleaning a panel, comprising:
a first process of injecting reaction gas into a gas inlet formed in a main body of a gas supply channel;
a second process of introducing the gas filled in the gas inlet into a gas chamber;
a third process of mixing the reaction gas with a carrier gas in the gas chamber;
a fourth process of introducing the mixed gas into a gap between dielectric plates through a connection slit formed in a lower portion of the gas chamber to extend in a longitudinal direction; and
a fifth process of cleaning the panel by causing radicals, which are generated while the mixed gas is converted into plasma within the gap between the dielectric plates, to be discharged onto an upper surface of the panel.

13. The method as claimed in claim 12, wherein the panel is positioned below the gap between the dielectric plates, and is then caused to relatively move with respect to the dielectric plates.

14. A method of manufacturing a display panel, comprising:
a process of depositing a pattern on a panel; and
a panel cleaning process according to claim 12 of removing impurities on the panel.
